(19) United States
(12) Patent Application Publication
(10) Pub. No.: US 2014/0208193 A1
(43) Pub. Date: Jul. 24, 2014

(54) METHOD AND ELECTRONIC DEVICE FOR SHARING RESOURCE FILE DATA

(71) Applicant: SAMSUNG ELECTRONICS CO., LTD., Suwon-si (KR)

(72) Inventors: Monil PARMAR, Noida (IN); Manish CHHABRA, Noida (IN)

(73) Assignee: SAMSUNG ELECTRONICS CO., LTD., Suwon-si (KR)

(21) Appl. No.: 14/160,755

(22) Filed: Jan. 22, 2014

(30) Foreign Application Priority Data
Jan. 21, 2013 (IN) 256/CHE/2013
Oct. 31, 2013 (KR) 10-2013-0131509

(51) Int. Cl. G06F 17/22; G06F 3/0486

(52) U.S. Cl. CPC G06F 17/2235; G06F 3/0486
USPC 715/205

(57) ABSTRACT

A method of sharing resource file data in an electronic device is provided. The method includes providing a user interface including a source page and a target page by using a web browser, detecting an operation of dragging a hyperlink provided in the source page from the source page to the target page and dropping the dragged hyperlink onto the target page; and in response to detecting the operation of dropping, downloading resource file data associated with the hyperlink through a network to the target page and storing the resource file data in the target page.

### RELATED APPLICATIONS

This application claims priority from Indian Patent Application No. 256/CHE/2013, filed on Jan. 21, 2013, in the Indian Patent Office and Korean Patent Application No. 10-2013-0131509, filed on Oct. 31, 2013, in the Korean Intellectual Property Office, the disclosures of which are incorporated by reference herein in their entirety.

### BACKGROUND

1. Field

Methods, apparatuses, and articles of manufacture consistent with the present disclosure relate to sharing resource file data, and more particularly, to an electronic device and method for downloading resource file data from a source page to a target page.

2. Description of the Related Art

Resource file data on the web is downloaded from a web page by using one or more hyperlinks corresponding to the resource file data. A user customarily clicks on the hyperlink, and the resource file data is downloaded into a memory of the device. After this, the user may attach the downloaded resource file data to an email, in which case the resource file data is copied from the memory into a new memory location associated with the email, and the email may then be sent to one or more other users. However, there is a disadvantage with this related art method in that the user may send the resource file data to the receivers only after first downloading the resource file and storing the downloaded file in the memory, and then copying the downloaded resource file to a new location.

Furthermore, the downloaded resource file data may be converted from a first data format into a second data format. The method of the related art includes providing resource file data of the first data format as an input to a data converter. The data converter converts the resource file data of the first data format into resource file data of a second data format. The resource file data of the second data format is stored in a memory of an electronic device, and after storing the resource file data of the second data format in the memory, the resource data of the second format may then be attached to an email for transmission. However, there is an additional disadvantage in the related art method in that the user may attach the resource file data to the email only after converting the resource file data into a second data file format and then storing the converted resource file data in a memory.

### SUMMARY

According to an aspect of an exemplary embodiment, there is provided a method of sharing resource file data in an electronic device, the method comprising providing a user interface including a source page and a target page by using a web browser; detecting an operation of dragging a hyperlink provided in the source page from the source page to the target page and dropping the dragged hyperlink onto the target page; and in response to detecting the operation of dropping, downloading resource file data associated with the hyperlink through a network to the target page and storing the resource file data in the target page.

According to another aspect of an exemplary embodiment, there is provided a method of sharing resource file data in an electronic device, the method comprising providing a user interface including a source page and a target page by using a web browser; detecting an operation of dragging a hyperlink provided in the source page from the source page to the target page and dropping the dragged hyperlink onto the target page; and in response to detecting the operation of dropping, converting the hyperlink into a dummy icon and providing the dummy icon to the target page.

According to another aspect of an exemplary embodiment, there is provided a method of sharing resource file data in an electronic device, the method comprising providing a user interface including a source page by using a web browser; providing an attachment function option associated with a hyperlink provided in the source page; and in response to an operation of selecting the attachment function option, downloading resource file data associated with the hyperlink through a network and providing a target page to which the resource file data has been attached.

According to another aspect of an exemplary embodiment, there is provided an electronic device for sharing resource file data, the electronic device comprising a display which outputs a user interface; an input device which receives input; a communication interface which performs communication with an external device; a processor which processes the resource file data; and a memory which stores instructions to be processed by the processor, wherein the processor, in response to the instructions: outputs, on the display, a user interface including a source page and a target page by using a web browser; detects an operation, by the input device, of dragging a hyperlink in the source page from the source page to the target page and dropping the dragged hyperlink onto the target page; and in response to detection of the dropping operation, downloads resource file data associated with the hyperlink through a network to the target page and stores the resource file data in the target page.

According to another aspect of an exemplary embodiment, there is provided an electronic device for sharing resource file data, the electronic device comprising a display which outputs a user interface; an input device which receives an input; a communication interface which performs communication with an external device; a processor which processes the resource file data; and a memory which stores instructions to be processed by the processor, wherein the processor, in response to the instructions: outputs, on the display, a user interface including a source page and a target page by using a web browser; detects an operation, by the input device, of dragging a hyperlink provided in the source page from the source page to the target page and dropping the dragged hyperlink on the target page; and in response to detecting the operation of dropping, converts the hyperlink into a dummy icon and provides the dummy icon to the target page.

According to another aspect of an exemplary embodiment, there is provided an electronic device for sharing resource file data, the electronic device comprising a display which outputs a user interface; an input device which receives an input; a communication interface which performs communication with an external device; a processor which processes the resource file data; and a memory which stores instructions to be processed by the processor, wherein the processor, in response to the instructions: outputs, to the display, a user interface including a source page by using a web browser; provides an attachment function option associated with a hyperlink provided in the source page; and in response to an operation of selecting the attachment function option, downloads resource file data associated with the hyperlink through a network and outputs to the display a target page to which the resource file data has been attached.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a block diagram of an environment in which an exemplary embodiment is applied;

FIG. 2 is a block diagram illustrating an example of an electronic device according to an exemplary embodiment;

FIG. 3 is a diagram illustrating instructions performed in a processor to share resource file data, according to an exemplary embodiment;

FIG. 4 is a diagram illustrating an example of sharing resource file data by performing a drag and drop operation, according to an exemplary embodiment;

FIG. 5 is a diagram illustrating a result of sharing the resource file data of FIG. 4;

FIG. 6 is a diagram illustrating an example of sharing resource file data by using a hyperlink option, according to an exemplary embodiment;

FIG. 7 is a diagram illustrating a result of sharing the resource file data of FIG. 6;

FIG. 8 is a diagram illustrating another example of sharing resource file data by performing a drag and drop operation, according to an exemplary embodiment;

FIG. 9 is a diagram illustrating providing a format conversion function, according to an exemplary embodiment;

FIG. 10 is a flowchart illustrating a method of sharing resource file data by performing a drag and drop operation, according to an exemplary embodiment;

FIG. 11 is a flowchart illustrating a method of sharing resource file data by using a hyperlink dummy icon, according to an exemplary embodiment; and

FIG. 12 is a flowchart illustrating a method of sharing resource file data by using a hyperlink option, according to an exemplary embodiment.

### DETAILED DESCRIPTION

Reference will now be made in detail to embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

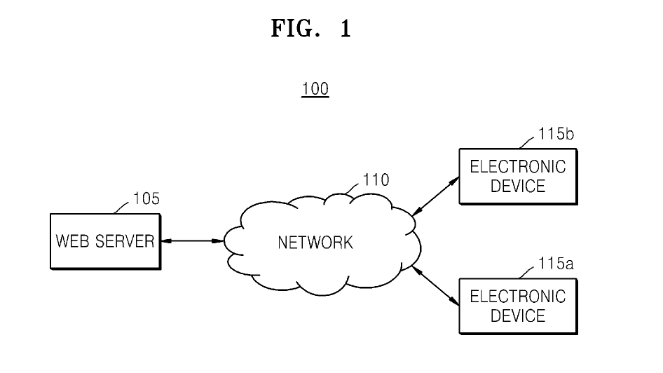

FIG. 1 is a block diagram of an environment in which an exemplary embodiment is applied.

As shown in FIG. 1, an environment 100 includes a web server 105, one or more electronic devices (e.g., an electronic device 115a and an electronic device 115b), and a network 110. The electronic device 115a and the electronic device 115b are communicatively connected to each other through the network 110. The electronic device 115a and the electronic device 115b are also communicatively connected to the web server 105 through the network. The electronic device 115a and the electronic device 115b may each include, for example, a desktop computer, a laptop computer, a mobile device, a personal digital assistant (PDA), a smartphone, and another portable device, but are not limited thereto. Examples of the network 110 may include a local area network (LAN), a wide area network (WAN), and/or a wireless network.

The electronic device 115a is configured to download web resources from a source page. A web resource includes file data. The resource file data may include a music file, a video, a portable document format (PDF) document, a Word document, and/or an image, but are not limited thereto. The resource file data may be downloaded by using a corresponding hyperlink in the source page. The source page includes a web page which is hosted by the web server 105.

A user of the electronic device 115a accesses the web page by using a web browser installed in the electronic device 115a. The user of the electronic device 115a may access the web page by using a web browser in a cloud. The web page includes a hyperlink for downloading file such as, for example, a PDF document. Furthermore, the user may access a target page (e.g., an email writing window) by using a web browser. The email writing window is used to write an email which may be transmitted to one or more other users, which function as receivers of the email.

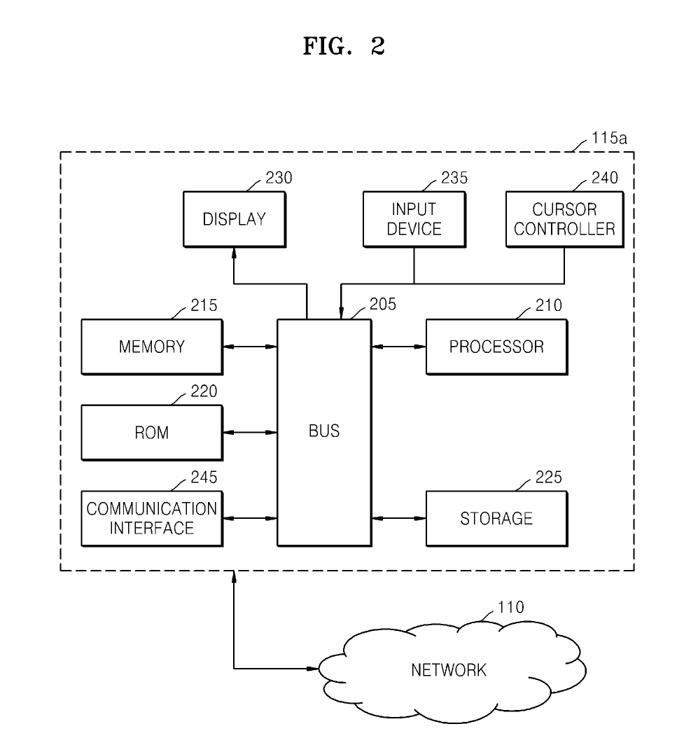

FIG. 2 is a block diagram illustrating an example of an electronic device 115a according to an exemplary embodiment.

Referring to FIG. 2, the electronic device 115a includes a bus 205, a processor 210, a memory 215, a read only memory (ROM) 220, a storage 225, a display 230, an input device 235, a cursor control 240, and a communication interface 245.

The bus 205 performs data communication between respective components within the electronic device 115a.

The processor 210 is connected to the bus 205 and processes information. In particular, the processor 210 processes instructions for sharing resource file data according to an exemplary embodiment. The processor 210 may include at least one central processing unit (CPU) and/or at least one microprocessor.

The memory 215 (e.g., a random access memory (RAM) or another dynamic storage device) which is connected to the bus 205 stores an information and an instruction to be executed by the processor 210. The memory 215 may be used in storing a temporary variable or other intermediate information while the processor 210 executes an instruction.

The ROM 220 connected to the bus 205 may also store instructions and static information for the processor 210.

The storage 225 may be a magnetic disk or an optical disk, and may be connected to a bus for information storage.

The display 230 displays processed data, may be coupled through the bus 205, and may include, for example, a cathode ray tube (CRT), a light-emitting diode (LED) display, and/or a liquid-crystal display (LCD) display.

The input device 235 may include alphabet keys, number keys, and/or other keys, and is connected to the bus 205. The input device 235 transmits information and command selection to the processor 210.

The input device 235 may be of another form such as, for example, a mouse, a trackball, and/or a cursor direction key that control a cursor movement. Alternatively, a cursor controller 240 (e.g., a mouse, a trackball, and/or a cursor direction key) may be provided separately from the input device 235 as shown in FIG. 2. The input device 235 and/or the cursor controller 240 transmits direction information and a command selection to the processor 210 and controls a cursor movement on the display 230.

Various exemplary embodiments are related to the use of the electronic device 115a in order to implement the technology described in the present specification. In some exemplary embodiments, the electronic device 115a performs the technology in response to the processor which executes the instructions included in the memory 215. Such instructions may be read to the memory 215 from another machine-readable medium (e.g., the storage 225). The processor 210 performs the operations described in the present specification by execution of instructions included in the memory.

In some exemplary embodiments, the processor 210 may include one or more processing units which perform one or more functions of the processor 210. The processing units are a hardware circuit which substitutes a software instruction, which performs a specific function, or is used together with the software instruction.

The term “machine-readable medium” of the present specification refers to any medium which participates in providing data so that a machine performs a specific function. In an exemplary embodiment implemented by using the electronic device 115a, various machine-readable media may participate in providing instructions to the processor 210 for execution. The machine-readable medium may be a volatile or non-volatile storage medium. The volatile medium includes a dynamic memory such as, for example, the memory 215. The non-volatile medium includes, for example, an optical or magnetic disk such as the storage 225. It may be advantageous for all such media to be tangible so that a physical mechanism for reading instructions in the machine may be detected.

The machine-readable media may include, for example, a floppy disk drive, a flexible disk drive, a hard disk drive, a magnetic tape or any other magnetic medium, a CD-ROM, an optical medium, a punch card, a paper tape, any other physical medium including a pattern of holes, a RAM, a programmable read-only memory (PROM), an erasable programmable read only memory (EPROM), a flash EPROM, a memory chip, and/or a cartridge.

In another exemplary embodiment, the machine-readable medium may be a transmission medium including coaxial cable, a copper wire, and an optical fiber, or a transmission medium including a wire including the bus 205. The transmission medium may be in the form of a sound or optical wave such as a radio wave and/or a wave which is generated during infrared data communication. Examples of machine-readable media may include an arbitrary medium readable by a portable electronic device, but are not limited thereto. For example, an instruction may be initially stored in a magnetic disk drive of a remote computer. The remote computer may load the instruction to the computer's dynamic memory and transmit the instruction on the phone line by using a modem. A local modem used by the electronic device 115a may receive data on the phone line, and may use an infrared transmitter to convert data into infrared signals. An infrared detector may receive data carried in infrared signals, and an appropriate circuit may provide the data to the bus 205. The bus transmits the data to the memory 215, and the processor 210 searches for an instruction from the memory and executes the instruction. The instruction received by the memory 215 may be selectively stored in the storage 225 before or after execution by the processor 210. It may be advantageous for all such media to be physically tangible so that instructions contained in the medium may be detected by a physical mechanism which reads the instruction to the machine.

The electronic device 115a includes a communication interface 245 connected to the bus 205. The communication interface 245 provides two-way data communication which communicatively connects the electronic device 115a with the web server 105 through the network 110. For example, the communication interface 245 may be an integrated services digital network (ISDN) card and/or a modem for providing data communication connection to a phone line of a corresponding form. As another example, the communication interface 245 may be a LAN card which provides data communication connection to a compatible LAN. In all such implementations, the communication interface 245 transmits and receives an electronic signal, an electromagnetic signal, or an optical signal, and such a signal carries a digital data stream which indicates various forms of information.

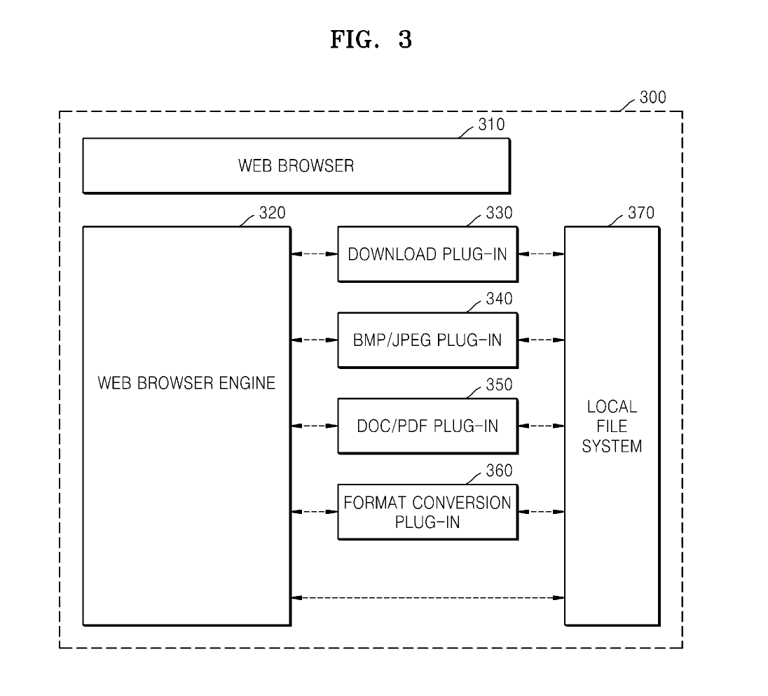

FIG. 3 is a diagram illustrating instructions performed in a processor to share resource file data, according to an exemplary embodiment.

Referring to FIG. 3, a module 300, which is used in the processor to share resource file data according to an exemplary embodiment, includes a web browser 310, a web engine browser 320, a download plug-in 330, a BMP/JPEG plug-in 340, a DOC/PDF plug-in 350, a format conversion plug-in 360, and a local file system 370.

The web browser 310 refers to an application program which is used in searching for information in an Internet network. General functions of the web browser 310 include opening a web page, providing recently visited uniform resource locators (URLs) and favorites, and storing a web page.

The web browser engine 320 is a software component which brings markup contents such as a hypertext markup language (HTML), an extensible markup language (XML), and an image file, and format information such as a cascading style sheets (CSS) and an extensible style sheet language (XSL), and displays formatted contents on a screen. The web browser engine renders contents in a contents area of a window of a monitor or a printer. Such a web browser engine may be embedded in a web browser, an email client, an e-book reader, etc.

The download plug-in 330 downloads resource file data associated with a hyperlink included in a source page, and stores the downloaded resource file data in a target page. The target page may be, for example, a web browser window, an email client window, or a local file system 370.

The BMP/JPEG plug-in 340 converts BMP format data into JPEG format data.

The DOC/PDF plug-in 350 converts DOC format data into PDF format data.

The format conversion plug-in 360 converts formats other than the BMP/JPEG plug-in 340 or DOC/PDF plug-in 350.

The local file system 370 is a file system for using a memory space within the electronic device 115a.

In an exemplary embodiment, the processor 210 of the electronic device 115a operates so that the user may access the source page and the target page. The source page and the target page are accessed by using a web browser which is installed in the electronic device 115a. The source page includes a web page which is hosted by one or more web servers (e.g., the web server 105). The target page includes an email writing window, a text message window, a memory location of the electronic device 115a, or a memory location of a remote electronic device.

The processor 210 of the electronic device 115a operates so that the user may perform a dragging function and a dropping function on a hyperlink. The hyperlink enables downloading of data. The dragging function is performed in the source page to drag the hyperlink, and the dropping function is performed in the target page to drop the hyperlink.

The processor 210 of the electronic device 115a is configured to call a download plug-in for downloading data associated with the hyperlink. The download plug-in is called when performing a dropping function in the target page.

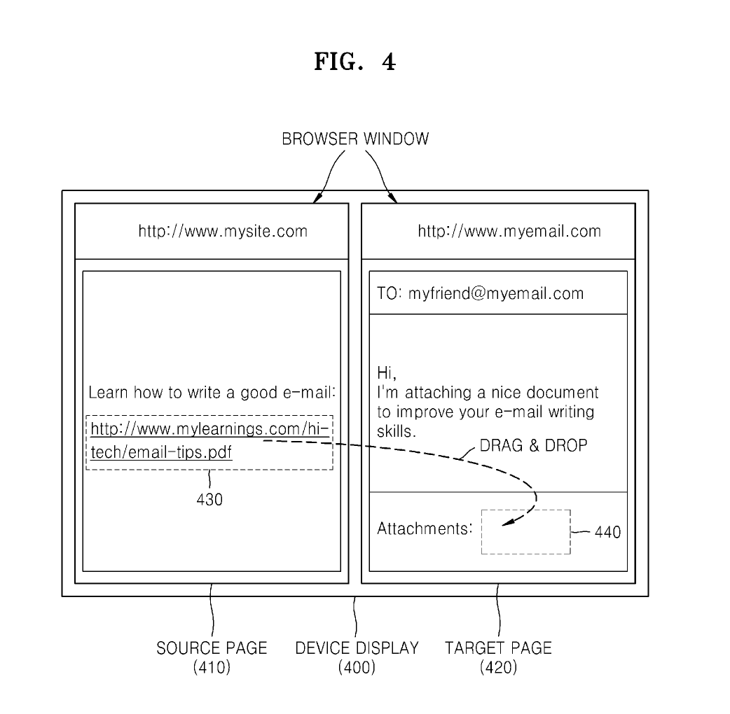

FIG. 4 is a diagram illustrating an example of sharing resource file data by performing a drag and drop operation, according to an exemplary embodiment.

Referring to FIG. 4, a browser window indicating a source page 410 and a browser window indicating a target page 420 are provided in a device display 400. When the user desires to store email-tips.pdf, which is resource file data associated with the hyperlink included in the source page 410, as an attachment in an email client page which is the target page 420, the user drags the hyperlink provided in the source page 410 from the source page 410 to the target page 420, and drops the dragged hyperlink 430 at a certain position 440 of the target page 420.

Likewise, if the user operation of dragging a hyperlink provided in the source page and dropping the dragged hyperlink on the target page is detected, the processor calls a download plug-in 330. The download plug-in 330 downloads email-tips.pdf, which is resource file data, from the source page through a network, and stores the downloaded email-tips.pdf in the target page 420 as an attached file.

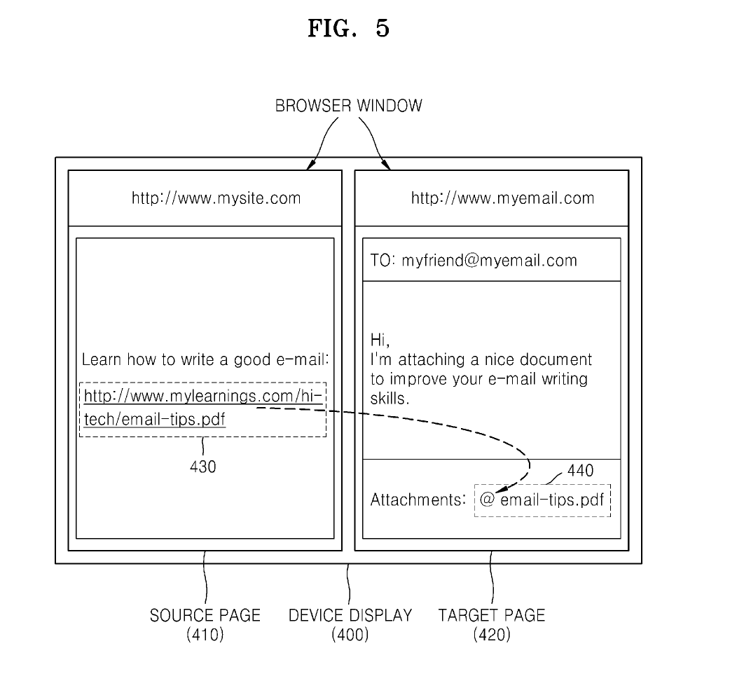

FIG. 5 is a diagram illustrating a result of sharing the resource file data of FIG. 4.

The resource file data, email-tips.pdf, is attached to the target page 420 according to operation of the download plug-in 330.

In another exemplary embodiment, the processor 210 is configured to call the download plug-in 330 by allowing the user to select an attachment option associated with the hyperlink. In an exemplary embodiment, the attachment option may be selected by right-clicking the hyperlink. If the user selects an attachment option to call a download plug-in for downloading data, the processor 210 is also configured to call a target page.

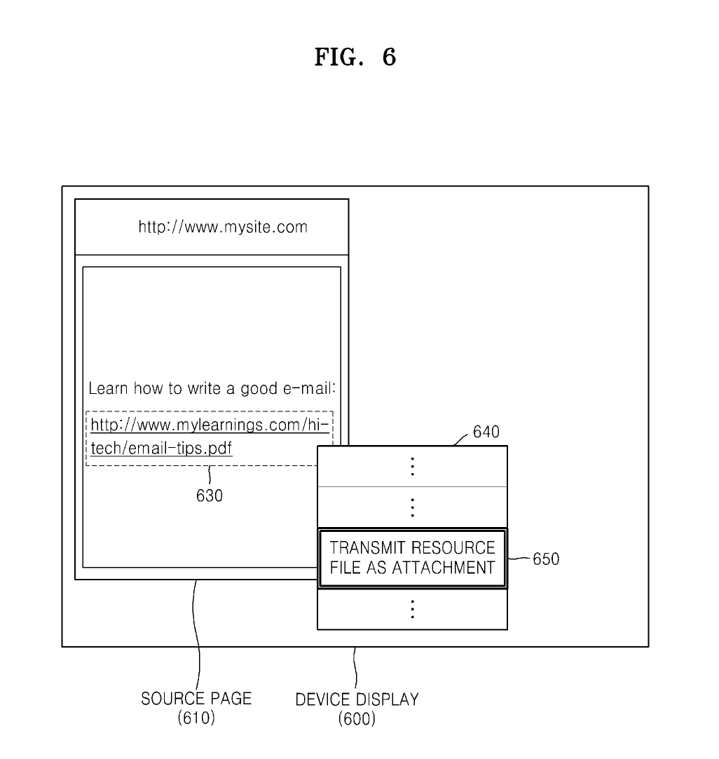

FIG. 6 is a diagram illustrating an example of sharing resource file data by using a hyperlink option, according to an exemplary embodiment.

Referring to FIG. 6, when the user right-clicks a hyperlink 630 on a source page 610 which is displayed on a device display 600, an option window 640 is provided, and the option window 640 includes an option “transmit resource file as attachment” 650. When the user selects this option 650, the download plug-in 300 is called, resource file data associated with the hyperlink 630 is downloaded, and the resource file data is attached to the target page 620.

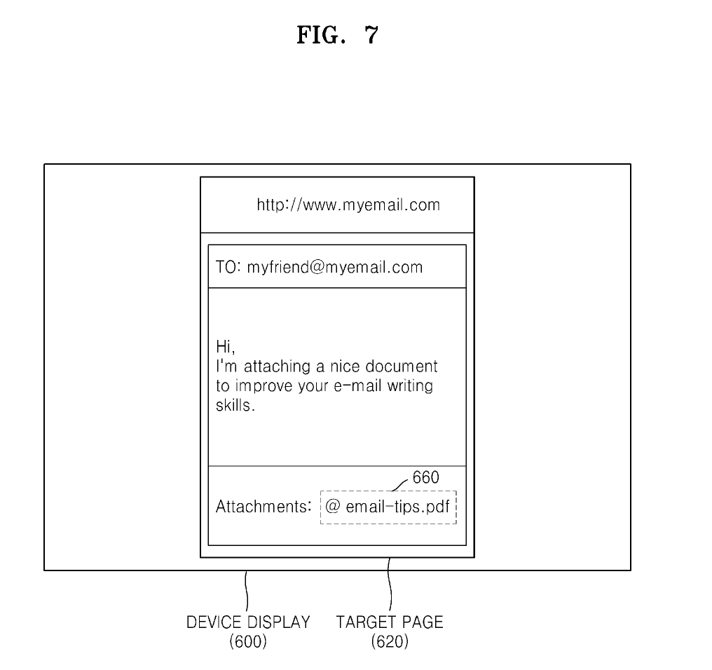

FIG. 7 is a diagram illustrating a result of sharing the resource file data of FIG. 6.

Referring to FIG. 7, the download plug-in 300 is called by selecting the option “transmit resource file as attachment” 650 (see FIG. 6), the resource file data associated with the hyperlink 630 is downloaded, and the resource file data is stored in the target page 620 as an attachment 660.

In another exemplary embodiment, the target page may be a local file system window.

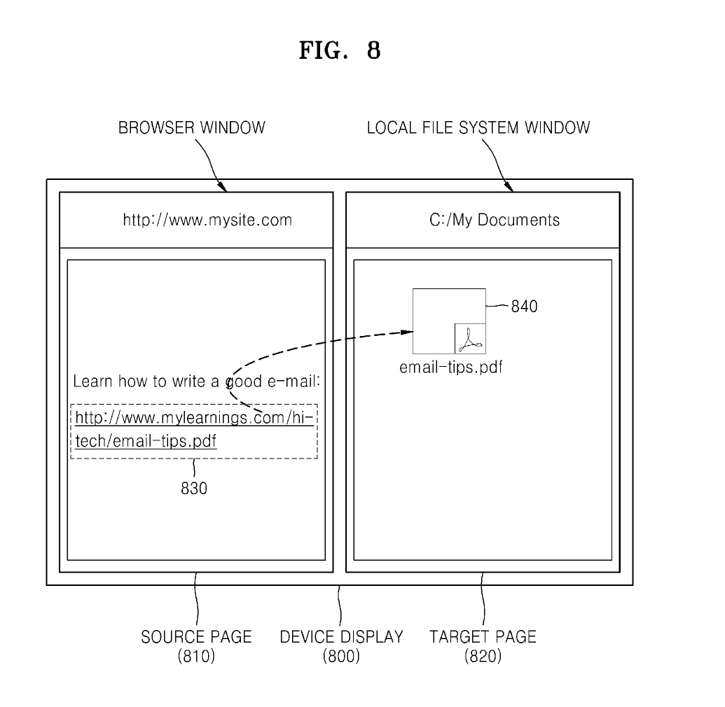

FIG. 8 is a diagram illustrating another example of sharing resource file data by performing a drag and drop operation, according to an exemplary embodiment.

Referring to FIG. 8, a browser window indicating a source page 810 and a local file system window indicating a target page 820 are provided to a device display 800. When the user desires to store email-tips.pdf, which is resource file data associated with a hyperlink 830 included in the source page 810, in a local file system, the user drags the hyperlink 830 provided in the source page 810 from the source page 810 to the target page 820 and drops the dragged hyperlink 830 at a certain position 840 of the target page 820.

Likewise, if an operation of dragging the hyperlink provided in the source page from the source page to the target page and dropping the dragged hyperlink on the target page is performed by the user, the processor calls the download plug-in 330. The download plug-in 330 downloads email-tips.pdf which is resource file data from the source page through a network, and stores the downloaded email-tips.pdf in the local file system indicated by the target page 420.

In another exemplary embodiment, the processor 210 is configured to call a download plug-in if the user provides a hyperlink to a target page. The providing of the hyperlink may be performed by, for example, copying a hyperlink and attaching the hyperlink to the target page. If the hyperlink is provided, the processor 210 operates so as to guide the target page to a web page including the hyperlink. Furthermore, when guided, the processor 210 operates so as to call a download plug-in to download data.

In another exemplary embodiment, the processor 210 is configured to call a download plug-in if a receiver of an email clicks a dummy icon. The dummy icon indicates a reference to a hyperlink corresponding to data. The processor 210 enables the user to drag the hyperlink from a web page to the email writing window and drop the hyperlink on the email writing window in the form of an icon before transmitting the email. The processor 210 enables a call of a download plug-in for downloading data if the receiver receives an email and clicks the dummy icon. Likewise, the processor 210 may be configured to call a download plug-in if the receiver of a text message corresponding to a text message window clicks the dummy icon.

The processor 210 of the electronic device 115a enables data attachment on the target page so that the user is not required to download data manually before attaching data to an email, and the user may transmit data as an attachment to the email without storing the data at a position in the memory.

In another exemplary embodiment, the processor 210 is configured to activate a plurality of data format conversion plug-ins when calling the download plug-in. The data format conversion plug-in enables conversion of data from one data format to another data format. The processor 210 downloads data before conversion. In an exemplary embodiment, the user may click a data conversion option in the email writing window for activation of the data format plug-in.

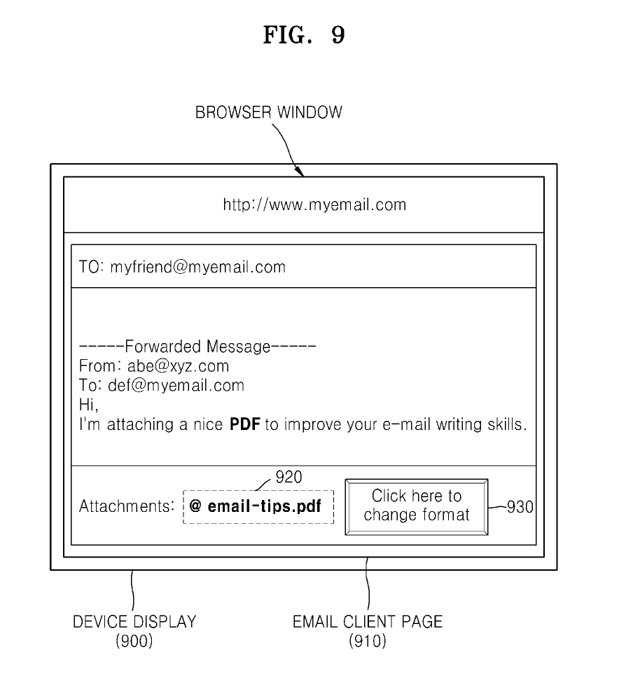

FIG. 9 is a diagram illustrating providing a format conversion function, according to an exemplary embodiment.

Referring to FIG. 9, resource file data, such as email-tips.pdf, is stored in an email client page 910 displayed on a device display 900 in an attached form 920, and an icon “click here to change format” 930 is provided. When the user clicks the icon 930, a format conversion plug-in is called, and the format of the resource file data is converted and re-attached.

The format conversion plug-in of the resource file data may also be called in one of the exemplary embodiments described above. That is, the processor 210 may be configured to attach the converted data in the email before transmitting the email to the receiver. The processor 210 may also be called to attach the converted data to a text message before transmitting the text message to the receiver. The processor 210 may also be configured to attach the converted data to a memory location of the electronic device 115a or a memory location of a remote electronic device.

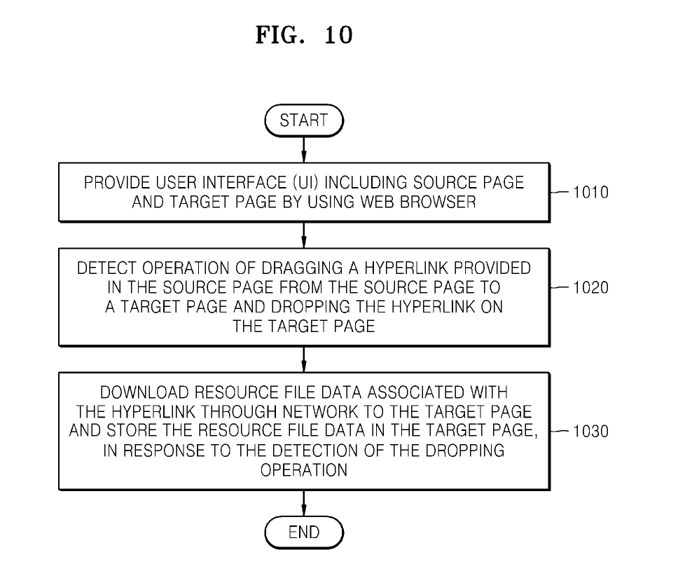

FIG. 10 is a flowchart illustrating a method of sharing resource file data by performing a drag and drop operation, according to an exemplary embodiment.

In operation 1010, a user interface (UI) including a source page and a target page is provided by using a web browser, which is performed as the processor of the electronic device performs instructions.

From the perspective of the user, the user may access the source page and the target page by using an electronic device (e.g., the electronic device 115a). The source page and the target page may be installed in the electronic device or may be accessed by using a web browser in a cloud. The source page includes a web page which is hosted by one or more web servers (e.g., the web server 105).

The web page may include one or more hyperlinks for downloading resource file data. The data may include a word document, a PDF document, an mp3 file, a video file, and an image, but are not limited to these examples.

The target page may include an email writing window for writing an email, a memory location of an electronic device, a memory location of a remote electronic device, or a text message window, but are not limited to these examples.

In operation 1020, an operation of dragging a hyperlink provided in the source page from the source page to the target page, and dropping the dragged hyperlink onto the target page is detected. This operation is detected by the processor of the electronic device according to instructions.

That is, the user performs a dragging function and a dropping function on the hyperlink corresponding to the resource file data. The dragging function is performed in the source page to drag the hyperlink from the source page to the target page. The dropping function is performed in the target page to drop the hyperlink on the target page. The dragging function and the dropping function may be performed by using a pointing device. Some examples of the pointing device are a mouse, a stylus, and a finger, but the pointing device is not limited to these examples.

In operation 1030, the resource file data is stored in the target page by downloading resource file data associated with the hyperlink through a network to the target page in response to the detection of the dropping operation. The operation is performed as the processor of the electronic device performs instructions.

That is, when the dropping operation is performed in the target page of the user, the processor calls a download plug-in in order to download resource file data associated with the hyperlink to the target page.

Furthermore, in another exemplary embodiment, the download plug-in is called by providing a hyperlink to the target page. For example, the provision of the hyperlink may be performed by enabling the user to copy a hyperlink from one or more source pages and attach the hyperlink to the email writing window. In response to providing the hyperlink, the email writing window is guided to the source page including the hyperlink. When guided, the download plug-in is called so that the resource file data may be downloaded to the target page.

By calling the download plug-in, the downloaded resource file data is attached to the target page. When the target page includes an email writing window, the downloaded resource file data is added to the email as an attachment. The email including an attachment may be transmitted to the receiver. If the target page includes a text message window, the downloaded resource file data is added to the text message as an attachment. Furthermore, if the target page includes a memory location of an electronic device and a memory location of a remote electronic device, the attachment of the resource file data is stored at the memory location. For example, a PDF document associated with the hyperlink included in a source page is downloaded by a download plug-in so as to enable attachment of the PDF document to an email. Similarly, if a hyperlink is dropped at the memory location of the electronic device 115a, a download plug-in is called so as to enable downloading of the PDF document and storage of the PDF document at the memory location of the electronic device 115a.

In some exemplary embodiments, a plurality of data format conversion plug-ins may convert data from one data format to another data format. The activation of a data conversion plug-in may be performed by clicking a data conversion option at an email writing window or a text message window. When the data conversion option is clicked, the resource file data is downloaded and the list of extension conversion options is displayed, and thus the user may select one of the extension conversion options. The data conversion plug-in corresponding to the extension conversion option selected by the user is activated to convert data from one data format into another data format. The converted data may be attached to the email before transmitting the email to the receiver. The converted data may be stored at the memory location of the electronic device or the memory location of the remote electronic device.

For example, a PDF document may be converted into a Word document by a data conversion plug-in.

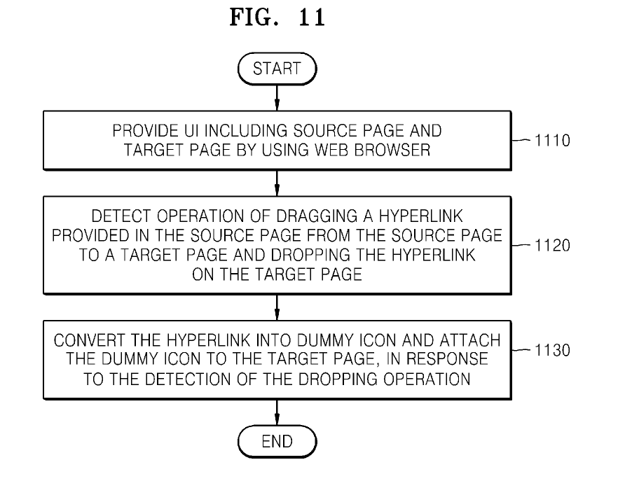

FIG. 11 is a flowchart illustrating a method of sharing resource file data by using a hyperlink dummy icon, according to an exemplary embodiment. Each operation of FIG. 11 may be performed by performing each instruction in the processor.

In operation 1110, a UI including a source page and a target page is provided by using a web browser.

In operation 1120, an operation of dragging a hyperlink provided in the source page from the source page to a target page and dropping the dragged hyperlink on the target page is detected.

In operation 1130, the hyperlink is converted into a dummy icon and is then attached to the target page in response to the detection of the dropping operation.

That is, if the user drags the hyperlink from the source page to the target page and drops the hyperlink onto the target page (e.g., an email writing window), a dummy icon may be attached so that the dummy icon may be shown to the receiver as an attachment. When dropped, the hyperlink is converted into a dummy icon, and the dummy icon is attached to the email. The email including the dummy icon is transmitted to the receiver. When receiving the email, the receiver may click a dummy icon to call a download plug-in for downloading data. The call of the download plug-in includes a hyperlink, and the receiver is guided to the web page which downloads resource file data corresponding to the hyperlink. Similarly, the download plug-in may be called by clicking a dummy icon attached to the text message corresponding to the text message window.

For example, the dummy icon may show a reference to the hyperlink corresponding to a document, such as a PDF document. The dummy icon may exist in the web page, and the dummy icon may be a feature of an email service provider which provides an email. The user may drag a dummy icon from the web page, and the dummy icon may be dropped to the email writing window before transmitting the email corresponding to the email writing window. The email including the dummy icon may be transmitted with an icon or hyperlink which may be embedded in the email. When the email is received, the receiver may click a dummy icon to call a download plug-in. When the download plug-in is called, a document, such as the PDF document, corresponding to the hyperlink expressed by the dummy icon is downloaded. Similarly, the user may click a dummy icon in a text message to call a download plug-in for downloading a document, such as a PDF document.

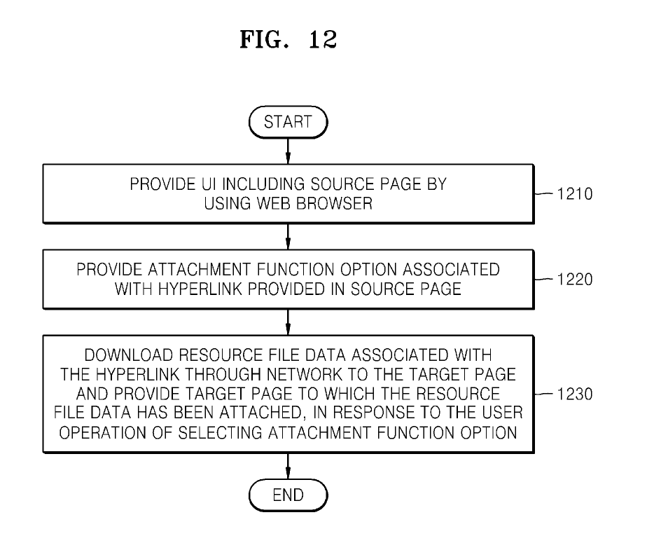

FIG. 12 is a flowchart illustrating a method of sharing resource file data by using a hyperlink option, according to an exemplary embodiment. Each operation of FIG. 12 may be performed as the processor of the electronic device performs instructions.

In operation 1210, a UI including a source page is provided by using a web browser.

In operation 1220, an attachment function option associated with the hyperlink provided in the source page is provided.

In operation 1230, in response to the user operation of selecting the attachment function option, the resource file data associated with the hyperlink is downloaded to the target page and the target page to which the resource file data has been attached is provided.

That is, in an exemplary embodiment, the download plug-in is called by selecting an attachment option associated with the hyperlink. In an example, the user may right-click the hyperlink to select the attachment option. The activation of the target page becomes possible and the calling of the download plug-in becomes possible by the selection of the attachment option. The downloading of data becomes possible by calling the download plug-in.

The attachment option selected by the user enables the user to access the email writing window. Furthermore, the attachment option calls a download plug-in in the email writing window so as to enable downloading of a document, such as a PDF document, associated with a hyperlink to the target page and enable attachment of the document to an email corresponding to the email writing window. Similarly, the user may call an attachment option which calls a download plug-in in a text message window so that the document is attached to the text message.

The exemplary embodiments described herein enable data attachment to an email or a desired memory location by performing a dragging function and a dropping function in the hyperlink without user's manual downloading operation of data in a memory location of the electronic device and then copying the downloaded data to the email or the desired memory location. Furthermore, an attachment option does not first download data to a memory and open the email writing window, but enables automatic calling of the email writing window to download data directly to the email writing window and attach the data to the email. Furthermore, the provision of the hyperlink does not require the user to attach data which has first been downloaded and stored in a memory location, but enables implicit calling of the download plug-in for downloading data to an email and attaching the data to the email. Furthermore, a user may transmit a dummy icon including a hyperlink in place of a large file such that the user does not need to transmit a file which exceeds a maximum transmission data limit. Yet in this case, the receiver may still download data because the dummy icon guides the receiver to the web page including the hyperlink. Furthermore, the method enables the user to convert data from one data format into another data format, and enables the converted data to be transmitted.

In addition, other exemplary embodiments may also be implemented through computer-readable code/instructions in/on a medium, e.g., a computer-readable medium, to control at least one processing element to implement any above described exemplary embodiments. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element may include a processor or a computer processor, and processing elements may be distributed and/or included in a single device.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present inventive concept as defined by the following claims.

What is claimed is:

1. A method of sharing resource file data in an electronic device, the method comprising:
providing a user interface including a source page and a target page by using a web browser;
detecting an operation of dragging a hyperlink provided in the source page from the source page to the target page and dropping the dragged hyperlink onto the target page; and
in response to detecting the operation of dropping, downloading resource file data associated with the hyperlink through a network to the target page and storing the resource file data in the target page.

2. The method of claim 1, wherein the target page includes at least one of an email writing window, a memory location of the electronic device, a text message window, and a memory location of a remote electronic device.

3. The method of claim 1, wherein the target page is an email writing window, and the method comprises storing the resource file data in the target page as an attachment file.

4. The method of claim 1, wherein the target page is a window indicating a certain memory location of the electronic device, and the method comprises storing the resource file data at the certain memory location of the electronic device.

5. The method of claim 1, further comprising:
providing an icon for providing a function of converting the resource file data stored in the target page from a first data format into a second data format.

6. A method of sharing resource file data in an electronic device, the method comprising:
providing a user interface including a source page and a target page by using a web browser;
detecting an operation of dragging a hyperlink provided in the source page from the source page to the target page and dropping the dragged hyperlink onto the target page; and
in response to detecting the operation of dropping, converting the hyperlink into a dummy icon and providing the dummy icon to the target page.

7. A method of sharing resource file data in an electronic device, the method comprising:
providing a user interface including a source page by using a web browser;
providing an attachment function option associated with a hyperlink provided in the source page; and
in response to an operation of selecting the attachment function option, downloading resource file data associated with the hyperlink through a network and providing a target page to which the resource file data has been attached.

8. An electronic device for sharing resource file data, the electronic device comprising:
a display which outputs a user interface;
an input device which receives input;
a communication interface which performs communication with an external device;
a processor which processes the resource file data; and
a memory which stores instructions to be processed by the processor,
wherein the processor, in response to the instructions:
outputs, on the display, a user interface including a source page and a target page by using a web browser;
detects an operation, by the input device, of dragging a hyperlink in the source page from the source page to the target page and dropping the dragged hyperlink onto the target page; and
in response to detection of the dropping operation, downloads resource file data associated with the hyperlink through a network to the target page and stores the resource file data in the target page.

9. The electronic device of claim 8, wherein the target page includes at least one of an email writing window, a memory location of the electronic device, a text message window, and a memory location of a remote electronic device.

10. The electronic device of claim 8, wherein the target page is an email writing window, and the processor stores the resource file data in the target page as an attachment file.

11. The electronic device of claim 8, wherein the target page is a window indicating a certain memory location of the electronic device, and the processor stores the resource file data at the certain memory location of the electronic device.

12. The electronic device of claim 8, wherein the processor performs an instruction for providing, in the target page, an icon for providing a function of converting the resource file data stored in the target page from a first data format into a second data format.

13. An electronic device for sharing resource file data, the electronic device comprising:
a display which outputs a user interface;
an input device which receives an input;
a communication interface which performs communication with an external device;
a processor which processes the resource file data; and
a memory which stores instructions to be processed by the processor,
wherein the processor, in response to the instructions:
outputs, on the display, a user interface including a source page and a target page by using a web browser;
detects an operation, by the input device, of dragging a hyperlink provided in the source page from the source page to the target page and dropping the dragged hyperlink on the target page; and
in response to detecting the operation of dropping, converts the hyperlink into a dummy icon and provides the dummy icon to the target page.

14. An electronic device for sharing resource file data, the electronic device comprising:
a display which outputs a user interface;
an input device which receives an input;
a communication interface which performs communication with an external device;
a processor which processes the resource file data; and
a memory which stores instructions to be processed by the processor,
wherein the processor, in response to the instructions:
outputs, to the display, a user interface including a source page by using a web browser;
provides an attachment function option associated with a hyperlink provided in the source page; and
in response to an operation of selecting the attachment function option, downloads resource file data associated with the hyperlink through a network and outputs to the display a target page to which the resource file data has been attached.

15. A computer-readable recording medium having recorded thereon a program for a method of sharing resource file data in an electronic device, the method comprising:
providing a user interface including a source page and a target page by using a web browser;
detecting an operation of dragging a hyperlink provided in the source page from the source page to the target page and dropping the dragged hyperlink onto the target page; and
in response to detecting the operation of dropping, downloading resource file data associated with the hyperlink through a network to the target page and storing the resource file data in the target page.

16. The electronic device of claim 8, wherein the memory includes a memory portion used generally by the web browser, and a memory portion used by the target page and, in response to the operation of dropping, the processor downloads the resource data file directly to the memory portion used by the target page, without storing the resource data file in the memory portion used generally by the web browser.

17. The computer-readable recording medium of claim 15, wherein the memory includes a memory portion used generally by the web browser, and a memory portion used by the target page and, in response to the operation of dropping, the processor downloads the resource data file directly to the memory portion used by the target page, without storing the resource data file in the memory portion used generally by the web browser.

18. The electronic device of claim 14, wherein the memory includes a memory portion used generally by the web browser, and a memory portion used by the target page and, in response to the operation of dropping, the processor directly outputs the target page to which the resource file data has been attached, without storing the resource data file in the memory portion used generally by the web browser.
